(19) United States
(12) Patent Application Publication
(10) Pub. No.: US 2017/0229852 A1
(43) Pub. Date: Aug. 10, 2017

(54) Electrical Box Support and Support System

(71) Applicant: ERICO INTERNATIONAL CORPORATION, Solon, OH (US)

(72) Inventors: Ronald Adam Jones, Cleveland Heights, OH (US); Raymond Scott Laughlin, Middlefield, OH (US)

(21) Appl. No.: 15/427,803

(22) Filed: Feb. 8, 2017

Related U.S. Application Data
(60) Provisional application No. 62/293,558, filed on Feb. 10, 2016.

(51) Int. Cl. H02G 3/12; F16M 13/02; E04C 3/32

(52) U.S. Cl. CPC H02G 3/121; E04C 3/32; F16M 13/022

(57) ABSTRACT

A support for mounting an electrical box relative to a stud can include a support arm and an attachment feature, with the attachment feature configured to secure the support arm to the stud, and the support arm configured to support the electrical box. The attachment feature can include an attachment section that has a first configuration and a second configuration. In the first configuration, the attachment section can support the support arm at a first depth relative to the stud. In the second configuration, the attachment section can be configured to be folded over itself to support the support arm at a second, smaller, depth relative to the stud.

### RELATED APPLICATIONS

This application claims priority to, and incorporates by reference, U.S. Provisional Patent Application 62/293,558, which is entitled “Electrical Box Support and Support System” and was filed Feb. 10, 2016.

### BACKGROUND

Conventional electrical box supports and related support systems can be used to mount one or more electrical boxes relative to a stud or other structures. In some conventional designs, a support system including an electrical box, a support bracket, a trim ring, an MC whip assembly, and other features can be fully pre-fabricated and assembled before installation on a stud (or studs). This can result in a relatively heavy assembly that can be relatively difficult to install at a desired location (e.g., a desired height) and orientation (e.g., perpendicular to a stud).

### SUMMARY

Some embodiments of the invention provide a support for mounting an electrical box relative to a stud. The support can include a support arm to hold the electrical box, and an attachment feature connected to the support arm. The attachment feature can include a first attachment section connected to the support arm via a first transition region, a second attachment section connected to the first attachment section, opposite the support arm, via a second transition region, and a third attachment section connected to the second attachment section, opposite the first attachment section, via a third transition region. The attachment feature can be bent in a first direction at the first transition region and bent in a second direction at the second transition region and the third transition region to form a first U-shaped profile to attach the support to the stud.

Some embodiments of the invention provide a support system for mounting a first electrical box and a second electrical box relative to a stud. A first support of the support assembly can include a first support arm to hold the first electrical box, and a first attachment feature connected to the first support arm and including at least one opening. A second support of the support assembly can include a second support arm to hold the second electrical box, and a second attachment feature connected to the second support arm and including at least one tab.

The first attachment feature can be bent in a first direction at a first transition region and bent in a second direction at a second transition region and a third transition region to form a U-shaped profile to attach the first support to the stud. The second attachment feature can be bent in the second direction at a fifth transition region and bent in the first direction at a sixth transition region to form a substantially L-shaped profile. The substantially L-shaped profile can be seated over the U-shaped profile and the at least one tab can engage the at least one opening to connect the first support to the second support and to the stud. The first electrical box can be supported by the first support arm on a first side of the stud, and the second electrical box can be supported by the second support arm on a second side of the stud.

Some embodiments of the invention provide a support for mounting an electrical box relative to a stud. The support can include a support arm to support the electrical box, and an attachment feature connected to the support arm and configured to secure the support arm to the stud. The attachment feature can include a stud-engagement section, and an attachment section that connects the stud-engagement section to the support arm. The attachment section can have a first configuration and a second configuration, each with the stud-engagement section engaging the stud. The attachment section, in the first configuration, can support the support arm at a first depth relative to the stud. The attachment section, in the second configuration, can be folded over itself at a folded portion, to support the support arm at a second depth relative to the stud, with the second depth being smaller than the first depth.

Some embodiments of the invention provide a support system for mounting electrical boxes relative to a stud. The support system can include a first support and a second support. The first support can include a first support arm for a first of the electrical boxes, a first stud-engagement section configured to engage the stud, and a first attachment section connecting the first support arm to the first stud-engagement section. The second support can include a second support arm for a second of the electrical boxes, a second stud-engagement section configured to seat over the first stud-engagement section to engage the stud, and a second attachment section connecting the second support arm to the second stud-engagement section. Each of the first and second attachment sections can have, respectively, a first configurations and a second configuration, to support the electrical boxes at different depths relative to the stud when the first stud-engagement section engages the stud and the second stud-engagement section is seated over the first stud-engagement section. Each of the first and second attachment sections, in the second configuration, can be folded over itself.

Some embodiments of the invention provide a method of supporting electrical boxes relative to a stud using at least one of a first support and a second support. A first support in a first configuration can be selected. In the first configuration, the first support can be configured to be secured to the stud without using tools and thereby to support a first of the electrical boxes relative to the stud at a first depth. The first support can be manipulated from the first configuration into a second configuration, in which the first support remains configured to be secured to the stud without using tools, and in which the first support is configured to support the first electrical box relative to the stud at a second depth that is smaller than the first depth. The first support can be secured to the stud, in the second configuration, without using tools. The operation of manipulating the first support into the second configuration can include folding an attachment section of the first support over itself into a U-shaped bend.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a left, front, bottom perspective view of a support for mounting an electrical box, according to one embodiment of the invention;

FIG. 2 is a left, front, bottom perspective view of the support of FIG. 1 in a telescopically extended configuration;

FIG. 3 is a partial left, front, bottom perspective view of a longitudinal end of the support of FIG. 1, with an attachment feature of the support in a first configuration;

FIGS. 4 through 6 are partial left, front, bottom perspective views of the longitudinal end of the support illustrated in FIG. 3, illustrating a process of placing the attachment feature in a second configuration;

FIG. 7 is a partial bottom plan view of the end of the support illustrated in FIG. 3, with the attachment feature in the second configuration;

FIG. 8 is a partial right, front, bottom perspective view of a longitudinal end of a support for mounting an electrical box, according to one embodiment of the invention, with an attachment feature in a first configuration;

FIGS. 9 and 10 are partial right, front, bottom perspective views of the longitudinal end of the support illustrated in FIG. 8, illustrating a process of placing the attachment feature in a second configuration;

FIG. 11 is a partial right, front, bottom perspective view of a longitudinal end of a support for mounting an electrical box, according to one embodiment of the invention;

FIG. 12 is a partial right, front, bottom perspective view of the support of FIG. 11 engaged with another support according to one embodiment of the invention;

FIGS. 13 and 14 are partial right, front, bottom perspective views of a longitudinal end of a support for mounting an electrical box, according to some embodiments of the invention, illustrating a process of placing an attachment feature of the support in an extended-depth configuration;

FIG. 15 is a left, front, bottom perspective view of a support for mounting an electrical box, according to one embodiment of the invention;

FIG. 16 is a partial left, front, bottom perspective view of a longitudinal end of the support of FIG. 15, with an attachment feature of the support in a first configuration;

FIGS. 17 and 18 are, respectively, a partial left, front, bottom perspective view and a partial bottom plan view of the support of FIG. 15 in a second configuration; and

FIG. 19 is a perspective view of the support of FIG. 15 after certain stages of manufacturing.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless otherwise specified or limited, the phrases “at least one of A, B, and C,” “one or more of A, B, and C,” and the like, are meant to indicate A, or B, or C, or any combination of A, B, and/or C, including combinations with multiple instances of A, B, and/or C. Likewise, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, the term “U-shaped” specifies a shape that includes a base portion, with at least two leg portions extending in generally similar (e.g., parallel) directions from the base portion. In some embodiments, a “U-shaped” structure can include leg portions extending from opposite ends of the base portion at substantially right angles to the base portion, with or without curved or chamfered connecting regions between the leg portions and the base portion. In some embodiments, a “U-shaped” structure can include legs of different lengths.

As used herein, unless otherwise specified or limited, the term “L-shaped” specifies a shape that includes a base portion and a leg portion extending away from the base portion. In some embodiments, an “L-shaped” structure can include a leg portion extending from a base portion at a substantially right angle to the base portion, with or without a curved or chamfered connecting region between the leg portion and the base portion.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some figures may include multiple instances of similar structures or structural relationships. For convenience of presentation, in select figures, only some of these similar structures or relationships may be specifically labeled with a reference number. One of skill in the art will recognize that the features not labeled with reference numbers can include similar aspects and perform similar functions to similar features that are labeled with reference numbers.

Embodiments of the invention can improve on conventional electrical box supports and support systems in different ways. For example, conventional electrical box supports or support systems can be relatively heavy, with contractors often needing assistance to efficiently install boxes at a desired height and with a perpendicular alignment relative to a stud. Some embodiments of the invention can provide a support or support system for mounting an electrical box that allows for relatively easy, and potentially tool-free, pre-positioning, staging, or “mocking-up” of the support or support system, along with an electrical box, prior to final installation of the support or support system with a screw gun or other tool.

Some embodiments of the invention can include a support that is formed from a single piece of material and includes a telescoping bracket with attachment features to attach the support to a stud without requiring separate fasteners. In some embodiments, the attachment feature can help to self-level the support on the stud without requiring the use of a separate level or other tool. In some embodiments, the attachment feature can be easily configured (e.g., bent or controllably broken and reassembled) to accommodate different depths of electrical boxes, while preserving the above-noted fastener- and/or tool-free attachment and self-leveling.

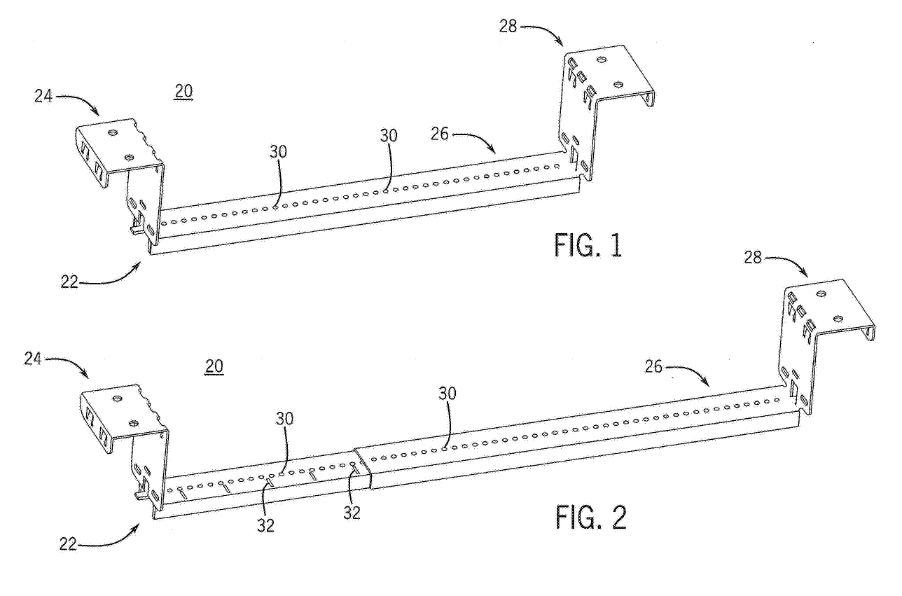

FIGS. 1 and 2 illustrate a support according to one embodiment of the invention, configured as a telescoping bracket 20. Generally, the bracket 20 is configured to support one or more electrical boxes (or other equipment) relative to one or more studs (or other structures).

The bracket 20 includes a support arm 22 with an attachment feature 24, and a support arm 26 with an attachment feature 28. The support arm 22 and the support arm 26 are generally configured as channels with C-shaped cross-sectional profiles, with the support arm 22 having a slightly smaller height and width than the support arm 26. Accordingly, the support arm 22 and the support arm 26 can be nested telescopically together. Usefully, this can allow a length of the bracket 20 to be telescopically adjusted to correspond to a length of a stud space or other mounting area.

As also discussed below, the attachment feature 24 and the attachment feature 28 are configured to secure the bracket 20 to respective studs on either side of a stud space, and to hold the bracket 20 in place relative to the studs without requiring separate fasteners. For example, the attachment features 24 and 28 can be configured to engage a stud S, as illustrated for the attachment feature 24 in FIG. 7. (The stud S is presented as an example only. Other sizes and configurations of studs can be similarly engaged by the attachment feature 24 or other attachment features.)

In the embodiment illustrated, the attachment feature 24 and the attachment feature 28 are substantially identical to each other, allowing the bracket 20 to be mounted in the stud space with the support arm 22 and the attachment feature 24 on either the left or the right side of the stud space. In other embodiments, attachment features on opposite ends of a support can be configured differently from each other.

In some embodiments, the support arms 22 and 26 and the attachment features 24 and 28 can be integrally formed from a single piece of starting material (not shown), such as a stamped metal sheet. For example, a profile for the support arm 22 and the attachment feature 24 can be stamped on one side of a metal sheet, and a profile for the support arm 26 and the attachment feature 28 can be stamped on another side of the metal sheet, in some cases with a perforated line or other break feature between the two sides. The support arm 22 and the attachment feature 24 can then be separated from the support arm 26 and the attachment feature 28 at the perforated line or other break feature, the attachment features 24 and 28 folded to an appropriate shape (as also discussed below), and the support arms 22 and 26 telescopically nested together for installation (as illustrated in FIGS. 1 and 2).

In different embodiments, different features can be included to assist in securing one or more electrical boxes (or other equipment) to the support arms 22 and 26, and to assist in obtaining and maintaining an appropriate length of the bracket 20. In the bracket 20, for example, the support arms 22 and 26 each include regularly spaced holes 30 as well as regularly spaced length indicators 32. The holes 30 can generally be used to secure an electrical box (not shown) to one or both of the support arms 22 and 26, or to limit the telescopic translation of the support arms 22 and 26 relative to each other. In the embodiment illustrated, the holes 30 are of uniform size and shape and are regularly arranged along the support arms 22 and 26. In other embodiments, other configurations are possible.

In some embodiments, attachment features can be manipulated into different configurations by a user. This can be useful, for example, in order to allow an attachment feature to be formed into an appropriate shape for engaging a particular stud. This can also be useful, for example, in order to configure a support to secure electrical boxes of different depths, with the electrical boxes appropriately flush with a relevant (e.g., wall) surface.

To this end, for example, each of the attachment features 24 and 28 includes a set of attachment sections and transition regions. Generally, attachment sections can be connected to each other by the transition regions, which can in turn be configured for relatively easy (e.g., manual) manipulation. This can be useful, for example, in order generally to allow the attachment features 24 and 28 to be relatively easily (e.g., manually) bent into desired configurations.

In some embodiments, attachment sections and transition regions can be arranged to allow a support to accommodate different depths of electrical boxes (or other equipment). In some embodiments, an adjustment of an attachment feature to accommodate different depths of electrical boxes, including through manipulation of attachment sections or transition regions, can be undertaken without substantially changing the way in which a particular support connects to a stud.

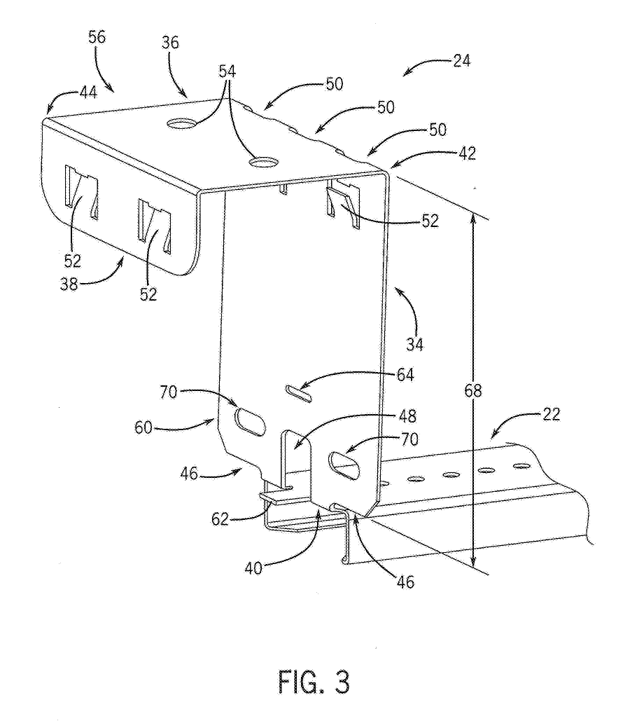

As illustrated in FIG. 3, the attachment feature 24 includes a first attachment section 34, a second attachment section 36, and a third attachment section 38. The first attachment section 34 is connected to the support arm 22 via a first transition region 40, the second attachment section 36 is connected to the first attachment section 34 via a second transition region 42, and the third attachment section 38 is connected to the second attachment section 36 via a third transition region 44.

As noted above, some transition regions can be configured to be relatively easily bent, in order to orient the attachment sections at different angles relative to each other and relative to other parts of a relevant support (e.g., a support arm for an electrical box). For example, the transition regions 40 includes openings configured as open slots 46 and a central opening 48, and the transition region 42 includes openings configured as closed slots 50. In other embodiments, other configurations are possible, including configurations in which the transition regions 40 and 42 do not include slots or other openings, and configurations in which one or more of the transition regions 40, 42 and 44 include one or more other features (e.g., scored lines, or various other types of openings) to facilitate bending of the attachment feature 24.

As illustrated in FIG. 3 in particular, in a first attachment configuration, the attachment feature 24 is formed (e.g., bent) into a U-shaped profile at one end, in order to provide a stud-engagement section 56 that will support the support arm 26 perpendicularly to, and behind, a particular stud. For example, the first attachment section 34 can be bent in a first direction (e.g., clockwise, as illustrated) at the transition region 40, to be oriented at an approximately 90-degree angle relative to the support arm 22. Similarly, the second attachment section 36 can be bent in a second direction (e.g., counterclockwise, as illustrated) at the transition region 42 to be oriented at an approximately 90-degree angle relative to the first attachment section 34. Further, the third attachment section 38 can be bent in the second direction at the transition region 44 to be oriented at an approximately 90-degree angle relative to the second attachment section 36.

With the attachment feature 24 configured as illustrated in FIG. 3, the U-shaped profile of the attachment feature 24 can be seated on a stud (not shown), with the second attachment section 36 seated on a front face of the stud, and with the first attachment section 34 and the third attachment section 38 extending along either side of the stud. The attachment feature 24 can accordingly help to secure the support arm 22 to the stud. Further, because the support arm 22, as configured in FIG. 3, generally needs to be disposed perpendicularly to a stud in order for the stud-engagement section 56 to seat on the stud, the support arm 22 may need to be generally disposed perpendicularly to the stud to secure the bracket 20 in place. Accordingly, the seating the attachment feature 24 on the stud can generally serve to self-level the bracket 20 relative to a stud (or studs).

In some embodiments, other structures on the attachment feature 24 can also assist in securing the attachment feature 24 to the stud, including though improving the fitment or the frictional connection between the attachment feature 24 and the stud. For example, in the configuration illustrated in FIG. 3, biased tabs 52 on the first attachment section 34 and the third attachment section 38 extend inwardly relative to the U-shaped profile of the attachment feature 24. When the attachment feature 24 is seated on the stud, the tabs 52 can press against or otherwise engage (e.g., snap around or into) corresponding features on the stud, in order to further hold the attachment feature 24 to the stud without requiring fasteners. In some embodiments, the tabs 52 can also help to accommodate variations in stud width (e.g., for studs from different manufacturers), so that the bracket 20 can be used in a wide range of settings.

With the attachment feature 24 secured to a stud (e.g., as described above), and with the attachment feature 28 (see FIGS. 1 and 2) similar secured to another stud (not shown), the attachment features 24 and 28 can hold the bracket 20 in a stud space between the studs without requiring the use tools, or of separate fasteners to secure the bracket 20 to the studs. Accordingly, the attachment features 24 and 28 can help to temporarily stage the bracket 20 in a desired location (e.g., prior to more permanent installation). Further, as also noted above, the configuration of the attachment features 24 and 28 relative to the support arms 22 and 26, can help operators to easily level the bracket 20 relative to the studs.

In some embodiments, as noted above, fasteners (and tools) can be used once the attachment features 24 and 28 have been used to secure the bracket 20 to a set of studs. For example, with the bracket 20 appropriately positioned, fasteners (e.g., screws) can be extended into the respective studs through holes 54 on the second attachment section 36 and similar openings on the attachment feature 28 (see FIGS. 1 and 2) to more permanently secure the bracket 20 to the studs.

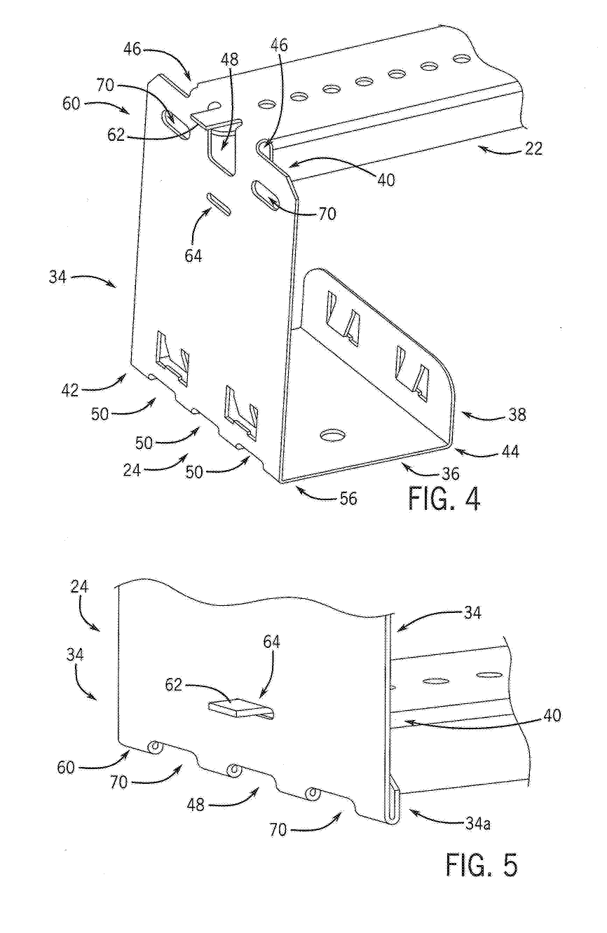

In some embodiments, attachment features can be bent between different configurations. In some cases, as also noted above, this can usefully allow the bracket 20 to be configured for different sizes of electrical boxes. As illustrated in FIGS. 4-6, for example, the attachment feature 24 can be bent from a first configuration (e.g., as illustrated in FIG. 1) to a second configuration. As illustrated in FIG. 4, with the same reference frame as for the bends described with regard to FIG. 3, the first attachment section 34 can first be bent in the second (e.g., counterclockwise) direction at the transition region 40. As illustrated in FIG. 5, the first attachment section 34 can then be bent in the first (e.g., clockwise) direction at a transition region 60 that includes closed slots 70 (see also FIG. 4). This can result in a portion 34a of the first attachment section 34 being folded over itself, with the remainder of the attachment section 34 extending in a similar direction as is illustrated in FIG. 3. (In some implementations, a different bending order can be used for this or for other embodiments.)

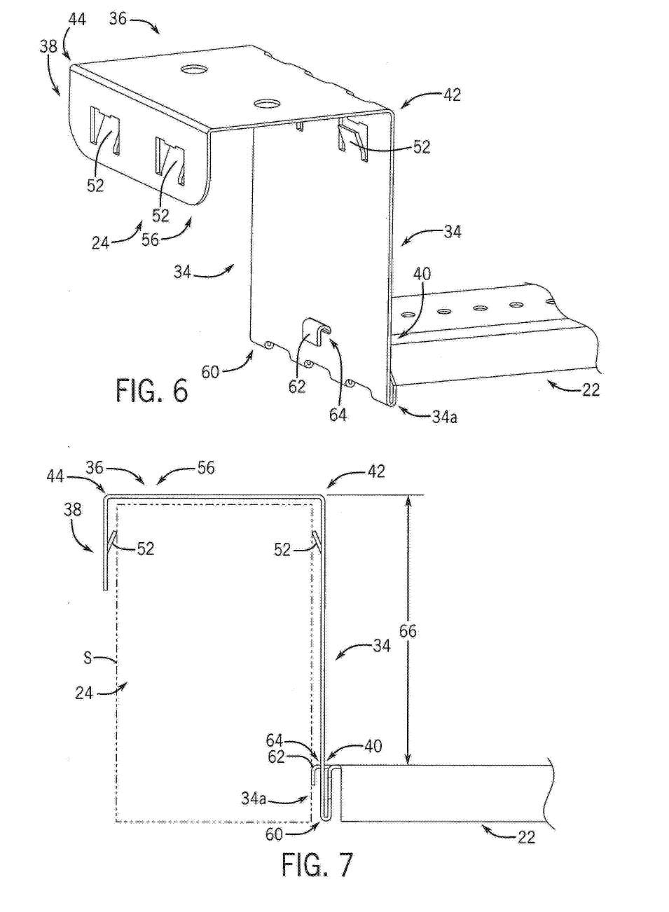

As illustrated in FIGS. 6 and 7, with the portion 34a of the attachment section 34 folded over as discussed above, with the second attachment section 36 bent in the second direction at the transition region 42, and with the third attachment section 38 bent in the second direction at the transition region 44, the attachment feature 24 can form a U-shaped profile similar to the profile illustrated in FIG. 3. However, due to the folding-over of the portion 34a of the first attachment section 34, the U-shaped profile illustrated in FIGS. 6 and 7 can exhibit a depth 66 (see FIG. 7) that is somewhat smaller than a depth 68 of the U-shaped profile illustrated in FIG. 3. Accordingly, when the bracket 20 is secured in a stud space, the configuration of the attachment feature 24 that is illustrated in FIGS. 6 and 7 can appropriately support an electrical box with a relatively small depth (e.g., 1.5 inches). In contrast, for example, in the configuration illustrated in FIG. 3, the attachment feature 24 can appropriately support an electrical box with a relatively large depth (e.g., 2.125 inches).

Of note, the different configurations illustrated for the attachment feature 24 do not substantially change the configuration of the stud-engagement section 56. As illustrated in FIGS. 3 and 6, for example, the stud-engagement section 56 retains its square-cornered U-shaped profile in both illustrated configurations, as well as the ability to secure the support arm 22 perpendicularly to a relevant stud. In other words, the attachment feature 24 substantially remains in a single configuration where it engages the relevant stud, even as the attachment feature 24 is otherwise reconfigured for different depths.

In some embodiments, features can be provided to secure an attachment section in a particular configuration. As illustrated in FIG. 5, for example, a tab 62 extends axially from a longitudinal end of the support arm 22. Further, a complimentary opening configured as a slot 64 extends through the first attachment section 34 just outside the portion 34a of the first attachment section 34. When the portion 34a is folded over, the tab 62 can accordingly be extended through the slot 64 and then folded over (see FIGS. 6 and 7) to secure the portion 34a of the first attachment section 34 to the support arm 22.

In some embodiments, a tab or other feature for securing an attachment feature in a particular configuration can be formed (or at least partly defined) by another feature. In some embodiments, such a tab or other feature can be formed by an opening or other feature of a transition region. As illustrated in FIG. 3, for example, the central opening 48 is formed around, and thereby at least partly defines, the tab 62. This can be useful, for example, in order to allow a single stamping (or other) operation to simultaneously define a feature to allow for relatively easy bending of the attachment feature 24 (e.g., the opening 48) as well as a feature to secure the attachment feature 24 after the bending (e.g., the tab 62).

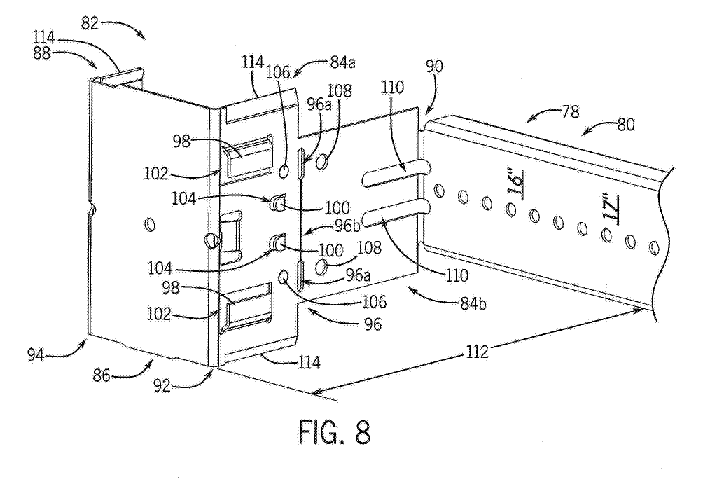

In other embodiments, other configurations are possible. For example, FIG. 8 illustrates a support according to another embodiment of the invention, configured as a bracket 78 with a support arm 80 and a corresponding attachment feature 82. Certain aspects of the support arm 80 and the attachment feature 82 are generally similar to certain aspects of the support arm 22 and the attachment features 24 and 28. For example, the support arm 80 includes a channel with C-shaped cross-sectional profile (not shown), that can be telescopically nested with another support arm (not shown) to accommodate different spacings between studs (or other structures). Similarly, the attachment feature 82 includes a first attachment section 84, a second attachment section 86, a third attachment section 88, and transition regions 90, 92 and 94. Accordingly, the attachment feature 82 can be folded (e.g., at the transition regions 90, 92, and 94) into a U-shaped profile (e.g., as illustrated in FIG. 8) for attachment to a stud (not shown).

Other aspects of the attachment feature 82 and the support arm 80 are somewhat different from aspects of the attachment features 24 and 28 and the support arm 22. For example, the attachment feature 82 includes a break feature 96 separating the first attachment section 84 into portions 84a and 84b. In the embodiment illustrated, the break feature 96 is configured as a pair of aligned slots 96a joined by a perforated or scored line 96b. In other embodiments, other configurations of the break feature 96 (or other break features) are possible, including configurations with only slots or other openings, with only perforated or scored lines, or with other features that facilitate controlled breaking of the first attachment section 84 into the portions 84a and 84b. In some embodiments, break features can extend continuously across a relevant structure (e.g., the first attachment section 84). In some embodiments, break features can be non-continuous (e.g., formed as a series of disconnected slots).

The attachment feature 82 includes two pairs of retaining tabs 98 and 100 that define corresponding retaining recesses 102 and 104, a pair of circular locating protrusions 106, a pair of circular locating holes 108, and a pair of elongate slots 110. These features can be useful, for example, to allow a depth of the bracket 78 to be adjusted (e.g., to accommodate different sizes of electrical boxes).

In the configuration illustrated in FIG. 8, the U-shaped profile of the attachment feature 82 exhibits a depth 112 between the support arm 80 and the second attachment section 86 that is relatively large. Accordingly, the bracket 78 can be installed to appropriately support a correspondingly large electrical box (e.g., with a depth of 2.125 inches).

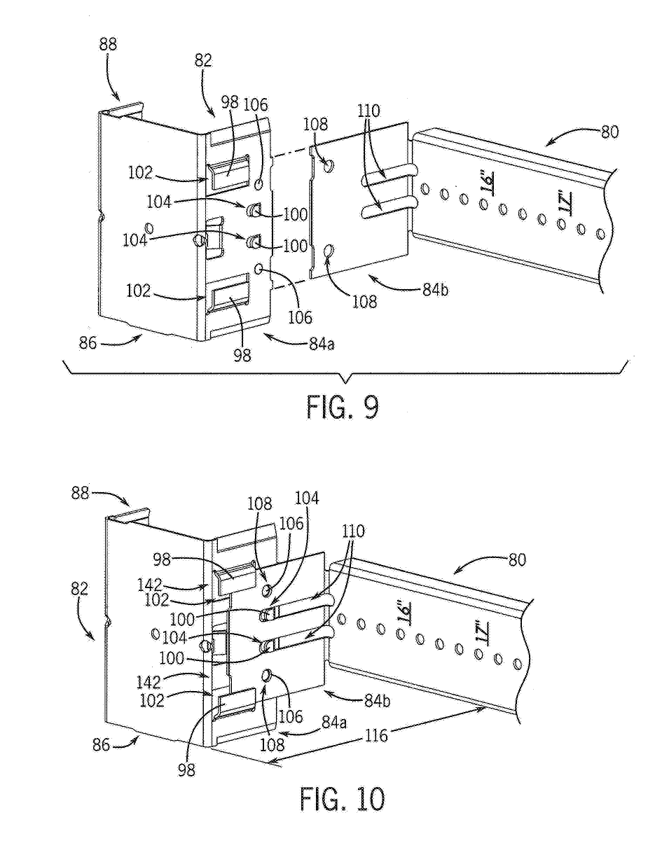

FIGS. 9 and 10 illustrate a method of adjusting the bracket 78 to a different configuration, with a smaller depth (e.g., to accommodate a 1.5 inch electrical box). As illustrated in FIG. 9, from the configuration of FIG. 8, the first attachment section 84 can be broken at the break feature 96 into the portions 84a and 84b, with the portion 84b remaining attached to the support arm 80.

Once broken apart, the portions 84a and 84b can be aligned for reattachment to the bracket 78 by inserting the sides of the portion 84b into the retaining recesses 102 on the portion 84a, and inserting the retaining tabs 100 on the portion 84a into the slots 110 on the portion 84b. The portions 84a and 84b can then be slid relative to each other until the end walls of the slots 110 are seated within the retaining recesses 104 (under the retaining tabs 100) and the circular locating protrusions 106 are seated in the circular locating holes 108. As illustrated in FIG. 10, this can result in a relatively rigid U-shaped profile for the attachment feature 82 that exhibits a new depth 116 between the support arm 80 and the second attachment section 86 that is somewhat smaller than the depth 112 illustrated in FIG. 8 (e.g., is approximately 1.5 inches).

In some embodiments, other features can be included. For example, as illustrated in FIG. 8 in particular, certain sides of the third attachment section 88 and of the portion 84a of the first attachment section 84 include angled edges 114. These can be useful, for example, to facilitate easy gripping of the attachment feature 82 by a user, to engage a stud, or for other purposes.

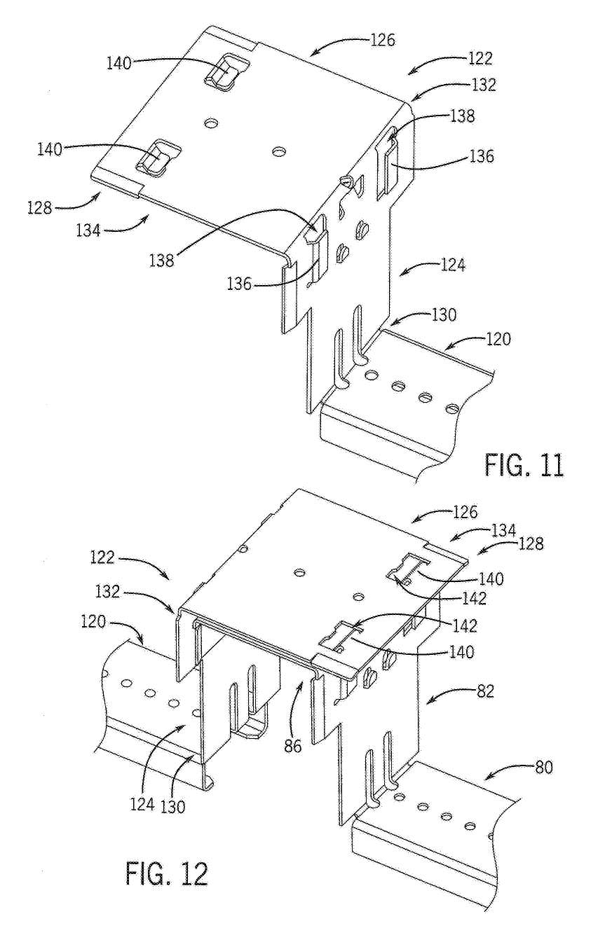

In some embodiments, multiple attachment features of multiple supports can be secured to the same stud. For example, FIG. 11 illustrates a part of a support that includes a support arm 120 for a telescoping bracket and an attachment feature 122. In some aspects, the attachment feature 122 is substantially similar to the attachment feature 82 (see, e.g., FIG. 8). For example, similarly to the attachment feature 82, the attachment feature 122 includes a first attachment section 124, a second attachment section 126, a third attachment section 128, and transition regions 130, 132, and 134. Also similarly to the attachment feature 82, the first attachment section 124 includes retaining tabs 136 aligned with openings 138 in the first attachment section 124, and the third attachment section 128 includes biased tabs 140.

In order to be attached to the same stud as the attachment feature 82, and as illustrated in FIGS. 11 and 12, the attachment feature 122 can be bent at the transition regions 130 and 132 to form a substantially L-shaped profile, with the third attachment section 128 extending substantially in parallel with the second attachment section 126 (e.g., with the transition region 134 un-bent), and with the tabs 140 extending towards the interior of the L-shaped profile. As illustrated in FIG. 12, with the attachment feature 82 seated on a stud (not shown), the attachment feature 122 can be seated on the attachment feature 82 (e.g., the second attachment section 126 seated on the second attachment section 86) with the tabs 140 engaging a pair of openings 142 on the attachment feature 82 (see also FIG. 10). In this way, for example, the attachment feature 122 can be attached to the stud via an attachment of the attachment feature 122 to the attachment feature 82, with the support arm 80 disposed to support an electrical box (not shown) on one side of the stud and the support arm 120 disposed to support an electrical box (not shown) on another side of the stud.

In the configuration illustrated in FIG. 12, the profiles of the attachment features 82 and 122 both exhibit a relatively large depth. This may be useful, for example, to accommodate relatively large electrical boxes. In other configurations, the attachment features 82 and 122 can be arranged with profiles that exhibit somewhat smaller depths (e.g., as described for the attachment feature 82 with regard to FIGS. 9 and 10 or as described for the attachment feature 24 with regard to FIGS. 4 through 7).

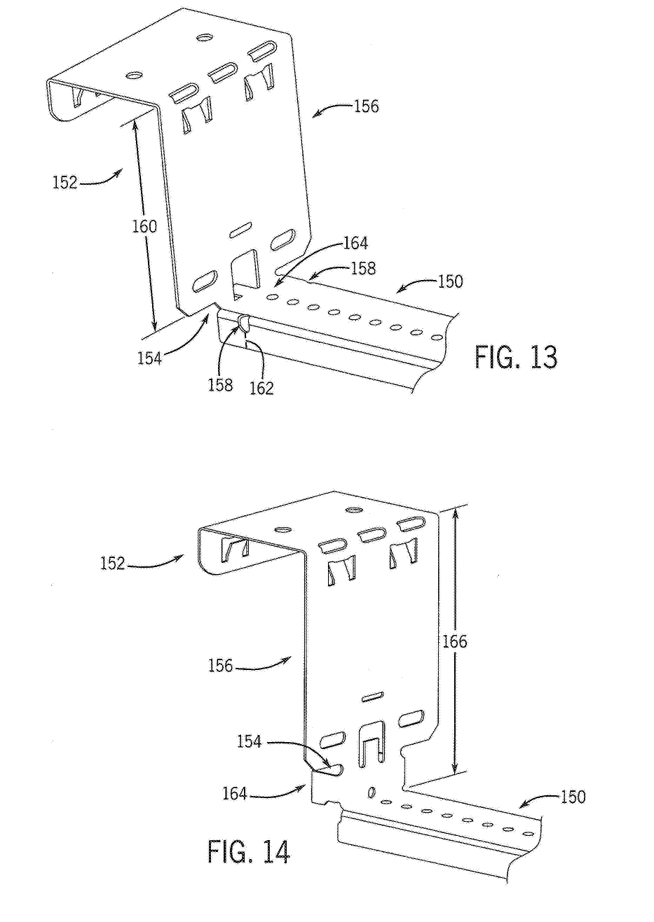

Other embodiments can be configured in other ways, in order to allow for changes in the depth of a profile of an attachment feature. For example, FIGS. 13 and 14 illustrate a part of a support that includes a support arm 150 and an attachment feature 152. Generally, the support arm 150 can be configured similarly to the support arm 22 (see, e.g., FIG. 3) and the attachment feature 152 can be configured similarly to the attachment feature 24 (see, e.g., FIG. 3). In contrast to the support arm 22, however, the support arm 150 includes a set of break features that are spaced apart from a transition region 154 between the support arm 150 and a first attachment section 156 of the attachment feature 152. In the embodiment illustrated, the break features are configured as a set of rounded openings 158 at the front corners of the support arm 150, although other configurations are possible.

In the configuration illustrated in FIG. 13, the attachment feature 152 defines a U-shaped profile with a depth 160 (e.g., 2.125 inches). In order to maintain a U-shaped profile, but provide for an increased depth (e.g., for a larger electrical box), the support arm 150 can be partially broken at a location that is generally aligned with the openings 158 (or another break feature). For example, the sides of the support arm 150 can be sheared in alignment with the openings 158 (e.g., as indicated by line 162). The transition region 154 can then be flattened and an extension region 164 of the support arm 150, between the openings 158 and the transition region 154, can be bent in the first (e.g., clockwise direction). In this way, for example, the extension region 164 and the first attachment section 156 can be disposed to extend generally in parallel with each other, and generally perpendicularly to the remainder of the support arm 150. As illustrated in FIG. 14, the attachment feature 152 can accordingly retain a U-shaped profile for engagement with a stud, while exhibiting a depth 166 that is somewhat larger (e.g., 2.5 inches) than the depth 160 (see FIG. 13).

In the embodiment illustrated, the increase of 0.125 inches from the depth 160 to the depth 166 can be obtained by locating the openings 158 on the support arm 150 at a distance of approximately 0.125 inches from the transition region 154 (i.e., by providing the extension region 164 with a length of approximately 0.125 inches). In other embodiments, different extensions of the depth 166 relative to the depth 160 can be obtained by locating the openings 158 (or other break features) at different distances from the transition region 154.

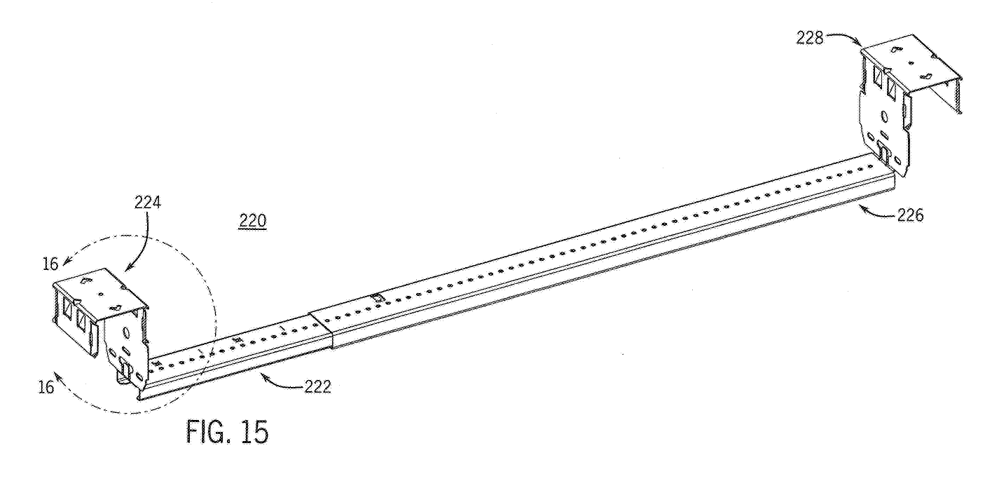

In other embodiments, other configurations are possible. For example, FIG. 15 illustrates a support according to one embodiment of the invention, configured as a telescoping bracket 220. Generally, the bracket 220 is configured to support one or more electrical boxes (or other equipment) relative to one or more studs (or other structures).

In some aspects, the bracket 220 is similar to the bracket 20 (see, e.g., FIGS. 1 and 2). For example, the bracket 220 includes a support arm 222 with an attachment feature 224, and a support arm 226 with an attachment feature 228. Similarly to the support arms 22 and 26, the support arms 222 and 226 are generally configured as channels with C-shaped cross-sectional profiles, which can be nested telescopically together. Usefully, this can allow a length of the bracket 220 to be telescopically adjusted to correspond to a length of a stud space or other mounting area.

Similarly to the attachment features 24 and 28, the attachment features 224 and 228 are configured to secure the bracket 220 to respective studs (e.g., the stud S illustrated in FIG. 18) on either side of a stud space, and to hold the bracket 220 in place relative to the studs without requiring separate fasteners. In the embodiment illustrated, the attachment features 224 and 228 are substantially identical to each other, allowing the bracket 220 to be mounted in the stud space with the support arm 222 and the attachment feature 224 on either the left or the right side of the stud space. In other embodiments, attachment features on opposite ends of a support can be configured differently from each other.

As also noted above, in some embodiments, attachment features can be manipulated into different configurations by a user. This can be useful, for example, in order to allow an attachment feature to be formed into an appropriate shape for engaging a particular stud. This can also be useful, for example, in order to configure a support to secure electrical boxes of different depths, with the electrical boxes appropriately flush with a relevant (e.g., wall) surface.

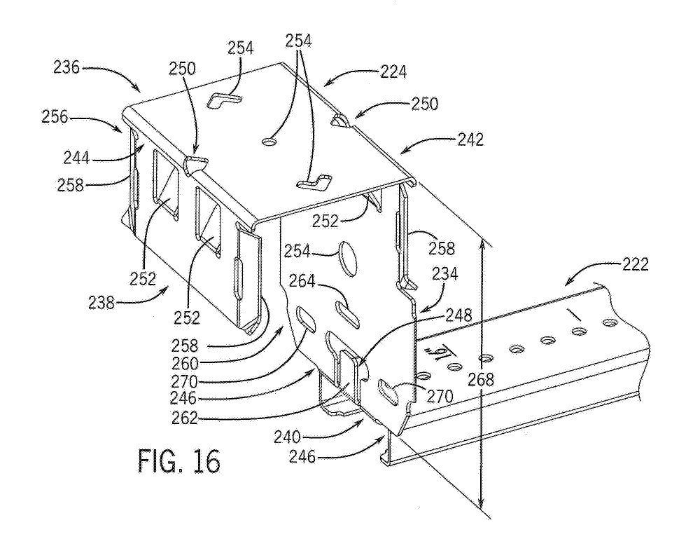

To this end, for example, each of the attachment features 224 and 228 includes a set of attachment sections and transition regions. As illustrated in FIG. 16, for example, the attachment feature 224 includes a first attachment section 234, a second attachment section 236, and a third attachment section 238. The first attachment section 234 is connected to the support arm 222 via a first transition region 240, the second attachment section 236 is connected to the first attachment section 234 via a second transition region 242, and the third attachment section 238 is connected to the second attachment section 236 via a third transition region 244.

As noted above, some transition regions can be configured to be relatively easily bent, in order to orient the attachment sections at different angles relative to each other and relative to other parts of a relevant support (e.g., a support arm for an electrical box). For example, the transition regions 240 includes openings configured as open slots 246 and a central opening 248, and the transition regions 242 and 244 include respective diamond-shaped openings 250. In other embodiments, other configurations are possible, including configurations in which the transition regions 240 and 242 do not include slots or other openings, and configurations in which one or more of the transition regions 240, 242 and 244 include one or more other features (e.g., scored lines, or other types of openings) to facilitate bending of the attachment feature 224.

As illustrated in FIG. 16 in particular, in a first attachment configuration, the attachment feature 224 is formed (e.g., bent) into a U-shaped profile at one end, in order to provide a stud-engagement section 256 that will support the support arm 226 perpendicularly to, and behind, a particular stud. For example, the first attachment section 234 can be bent in a first direction (e.g., clockwise, as illustrated) at the transition region 240, to be oriented at an approximately 90-degree angle relative to the support arm 222. Similarly, the second attachment section 236 can be bent in a second direction (e.g., counterclockwise, as illustrated) at the transition region 242 to be oriented at an approximately 90-degree angle relative to the first attachment section 234. Further, the third attachment section 238 can be bent in the second direction at the transition region 244 to be oriented at an approximately 90-degree angle relative to the second attachment section 236.

With the attachment feature 224 configured as illustrated in FIG. 16, the U-shaped profile of the stud-engagement section 256 can be seated on a stud (not shown in FIG. 16), with the second attachment section 236 seated on a front face of the stud, and with the first attachment section 234 and the third attachment section 238 extending along either side of the stud. The attachment feature 224 can accordingly help to secure the support arm 222 to the stud. Further, because the support arm 222, as configured in FIG. 16, generally needs to be disposed perpendicularly to a stud in order for the stud-engagement section 256 to seat on the stud, the support arm 222 may need to be generally disposed perpendicularly to the stud to secure the bracket 220 in place. Accordingly, the seating the attachment feature 224 on the stud can generally serve to self-level the bracket 220 relative to a stud (or studs).

In some embodiments, other structures on the attachment feature 224 can also assist in securing the attachment feature 224 to the stud, including though improving the fitment or the frictional connection between the attachment feature 224 and the stud. For example, in the configuration illustrated in FIG. 16, biased tabs 252 on the first attachment section 234 and the third attachment section 238 extend inwardly relative to the U-shaped profile of the attachment feature 224. When the attachment feature 224 is seated on the stud, the tabs 252 can press against or otherwise engage (e.g., snap around or into) corresponding features on the stud, in order to further hold the attachment feature 224 to the stud without requiring fasteners. In some embodiments, the tabs 252 can also help to accommodate variations in stud width (e.g., for studs from different manufacturers), so that the bracket 220 can be used in a wide range of settings.

Other features can also be provided. For example, a set of inwardly angled tabs 258 can be provided on the u-shaped profile of the attachment feature 224. The tabs 258, for example, can be used to further grip a stud or other structure, or to assist a user in manually gripping the bracket 220 for transport, assembly, or installation.

With the attachment feature 224 secured to a stud (e.g., as described above), and with the attachment feature 228 (see FIG. 15) similar secured to another stud (not shown), the attachment features 224 and 228 can hold the bracket 220 in a stud space between the studs without requiring the use tools, or of separate fasteners to secure the bracket 220 to the studs. Accordingly, the attachment features 224 and 228 help to temporarily stage the bracket 20 in a desired location (e.g., prior to more permanent installation). Further, as also noted above, the configuration of the attachment features 224 and 228 relative to the support arms 222 and 226, can help operators to easily level the bracket 220 relative to the studs.

In some embodiments, as noted above, fasteners (and tools) can be used once the attachment features 224 and 228 have been used to secure the bracket 20 to a set of studs. For example, with the bracket 220 appropriately positioned, fasteners (e.g., screws) can be extended into the respective studs through one or more of various openings 254 on the first or second attachment sections 234 and 236, and similar openings on the attachment feature 228 (see FIG. 15), to more permanently secure the bracket 220 to the studs.

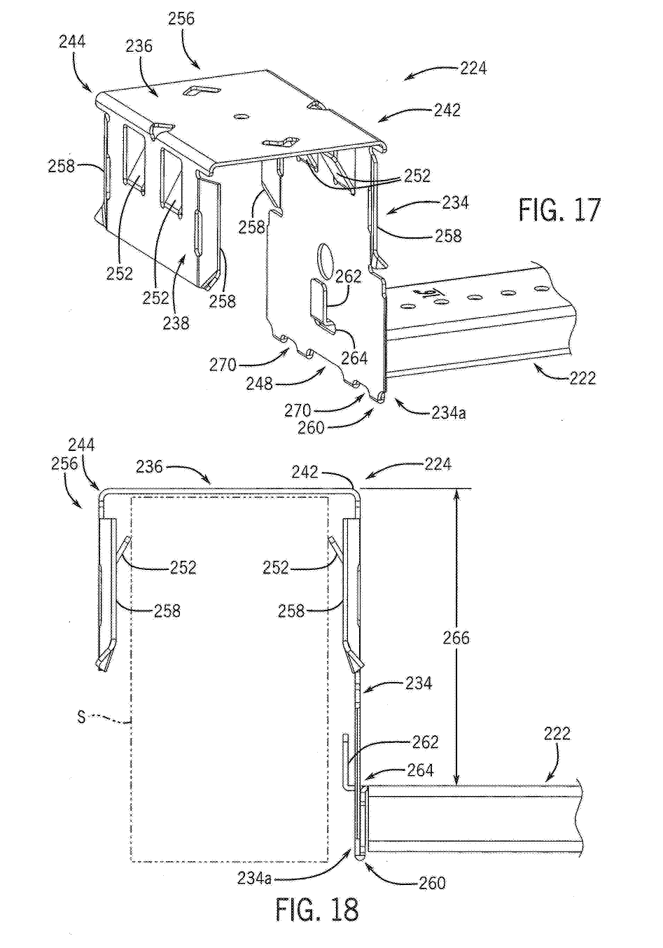

In some embodiments, attachment features can be bent between different configurations. In some cases, as also noted above, this can usefully allow the bracket 220 to be configured for different sizes of electrical boxes. As illustrated in FIGS. 17 and 18, for example, illustrate a second configuration for the attachment feature 224, which can be obtained by bending the attachment feature 224 from the first configuration illustrated in FIGS. 15 and 16.

Generally, the attachment feature 224 can be bent into the configuration of FIGS. 17 and 18 in a similar fashion as the attachment feature 24 can be bent into the configuration of FIGS. 6 and 7 (see discussion above). As a result, and as illustrated in FIG. 18 in particular, a portion 234a of the first attachment section 234 can be folded over itself at a transition region 260, as facilitated by a set of closed slots 270, so that the attachment feature 224 exhibits a depth 266 that is somewhat smaller than a depth 268 as illustrated in FIG. 16. Accordingly, when the bracket 220 is secured in a stud space, the configuration of the attachment feature 224 that is illustrated in FIGS. 17 and 18 can appropriately support an electrical box with a relatively small depth (e.g., 1.5 inches). In contrast, for example, in the configuration illustrated in FIG. 16, the attachment feature 224 can appropriately support an electrical box with a relatively large depth (e.g., 2.125 inches).

Of note, the different configurations illustrated for the attachment feature 224 do not substantially change the configuration of the stud-engagement section 256. As illustrated in FIGS. 16 and 18, for example, the stud-engagement section 256 retains its square-cornered U-shaped profile in both illustrated configurations, as well as the ability to secure the support arm 22 perpendicularly to a relevant stud. In other words, the attachment feature 224 substantially remains in a single configuration where it engages the relevant stud, even as the attachment feature 224 is otherwise reconfigured for different depths.

In some embodiments, further features can be provided to secure an attachment section in a particular configuration. As illustrated in FIG. 16, for example, a tab 262 extends from a longitudinal end of the support arm 222, as partly defined by the central opening 248. Further, a complimentary opening configured as a slot 264 extends through the first attachment section 234 just outside the portion 234a of the first attachment section 234. When the portion 234a is folded over, the tab 262 can accordingly be extended through the slot 264 and then folded over (see FIGS. 17 and 18) to secure the attachment feature 224 in the illustrated configuration.

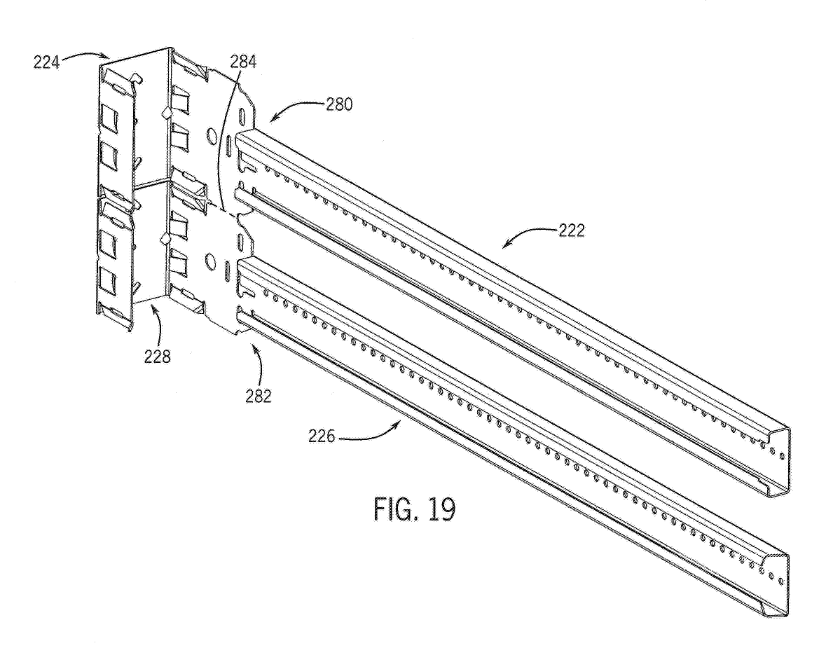

In some embodiments, the support arms 222 and 226 and the attachment features 224 and 228 can be integrally formed from a single piece of starting material, such as a stamped metal sheet. For example, as illustrated in FIG. 19, a profile 280 for the support arm 222 and the attachment feature 224 can be stamped on one side of a metal sheet, and a profile 282 for the support arm 226 and the attachment feature 228 can be stamped on another side of the metal sheet, with a perforated line 284 (or other break feature) between the two profiles 280 and 282. The support arm 222 and the attachment feature 224 can then be separated from the support arm 226 and the attachment feature 228 at the perforated line 284 (or other break feature), and the support arms 222 and 226 telescopically nested together for installation (e.g., as illustrated in FIG. 15).

In the embodiment illustrated in FIG. 19, the attachment features 224 and 228 have been folded into U-shaped profiles while the profiles 280 and 282 are still attached to each other. In other embodiments, the attachment features 224 and 228 can remain generally flat (or be otherwise configured differently), until after the profiles 280 and 282 are separated from each other. Similarly, in different implementations, the profiles 280 and 282 can be separated and nested telescopically as part of a manufacturing process, or can be shipped to installation sites still attached together (e.g., as illustrated in FIG. 19).

In other embodiments, still other configurations are possible. For example, aspects of one or more of the embodiments illustrated in the various FIGS. can be combined with each other, or with aspects of one or more other embodiments. In some embodiments, a bracket according to the invention may not include a telescoping configuration. For example, brackets according to the invention can be adjusted non-telescopically or can be configured with fixed lengths.

Thus, embodiments of the disclosed support and support system can provide various benefits compared to conventional electrical box supports systems. For example, in some embodiments, snap-on attachment features (e.g., the attachment features 24, 28, 82, 122, 152, 224, or 228) can allow easy mocking up (or other placement) of support installations without requiring separate fasteners, while also helping to self-level the supports as they are installed. In some embodiments, attachment features of a support can be relatively easily transitioned (e.g., bent and/or broken and reassembled) into different configurations in order to accommodate electrical boxes with different depths. In some embodiments, telescoping support arms can allow the disclosed supports to be used with a variety of widths of stud spaces. In some embodiments, an entire support or support system can be formed from a single sheet of material (e.g., coil steel).

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A support for mounting an electrical box relative to a stud, the support comprising:
a support arm to support the electrical box; and
an attachment feature connected to the support arm and configured to secure the support arm to the stud;
the attachment feature including a stud-engagement section, and an attachment section that connects the stud-engagement section to the support arm;
the attachment section having a first configuration and a second configuration, each with the stud-engagement section engaging the stud;
the attachment section, in the first configuration, supporting the support arm at a first depth relative to the stud; and
the attachment section, in the second configuration, being folded over itself at a folded portion, to support the support arm at a second depth relative to the stud, the second depth being smaller than the first depth.

2. The support of claim 1, wherein the attachment section, in the second configuration, is folded over itself to exhibit a U-shaped profile.

3. The support of claim 2, wherein two portions of the attachment section, each of which forms a respective leg of the U-shaped profile, extend in parallel with each other along the U-shaped profile.

4. The support of claim 1, wherein the attachment section, in the second configuration:
extends in a first direction away from the stud-engagement section, from the support arm to a first fold of the folded portion; and
extends in a second direction opposite the first direction, from the first fold to the stud-engagement section.

5. The support of claim 4, wherein the folded portion includes a second fold at a longitudinal end of the support arm, the second fold connecting the support arm to the attachment section.

6. The support of claim 1, further comprising:
a first opening in the attachment section; and
a tab disposed to extend through the first opening, with the attachment section in the second configuration, to secure the attachment section in the second configuration.

7. The support of claim 6, wherein the tab is integrally formed with and extends from a longitudinal end of the support arm.

8. The support of claim 7, further comprising:
a second opening in the attachment section, the second opening being adjacent to the longitudinal end of the support arm;
wherein a profile of the tab is at least partly defined by the second opening.

9. The support of claim 8, further comprising:
a third opening in the attachment section;
wherein a first bend of the folded portion is formed in alignment with the second opening and a second bend of the folded portion is formed in alignment with the third opening.

10. The support of claim 1, wherein the support arm forms part of a telescoping assembly, to adapt the support for different stud spacings.

11. The support of claim 1, wherein the stud-engagement section is configured to engage the stud, to secure the support to the stud, without the use of tools.

12. A support system for mounting electrical boxes relative to a stud, the support system comprising:
a first support including a first support arm for a first of the electrical boxes, a first stud-engagement section configured to engage the stud, and a first attachment section connecting the first support arm to the first stud-engagement section; and
a second support including a second support arm for a second of the electrical boxes, a second stud-engagement section configured to seat over the first stud-engagement section to engage the stud, and a second attachment section connecting the second support arm to the second stud-engagement section;
each of the first and second attachment sections having, respectively, a first configurations and a second configuration, to support the electrical boxes at different depths relative to the stud when the first stud-engagement section engages the stud and the second stud-engagement section is seated over the first stud-engagement section; and
each the of first and second attachment sections, in the respective second configuration, being folded over itself.

13. The support system of claim 12, wherein the first attachment section, in the second configuration, is folded over itself to exhibit a U-shaped profile.

14. The support system of claim 13, wherein a first leg of the U-shaped profile extends in a first direction, from the first support arm to a bend of the U-shaped profile; and
wherein a second leg of the U-shaped profile extends in a second direction opposite the first direction, from the bend to the first stud-engagement section.

15. The support system of claim 12, wherein the first support further includes:
a first opening in the first attachment section; and
a tab disposed to extend through the first opening to secure the first attachment section in the second configuration.

16. The support system of claim 15, wherein the tab extends from a longitudinal end of the first support arm.

17. The support system of claim 15, wherein the first attachment section, in the second configuration, is folded over itself to exhibit a U-shaped profile;
wherein the first attachment section further includes a second opening that at least partly defines a profile of the tab; and
wherein a first bend defining the U-shaped profile is formed in alignment with the second opening.

18. A method of supporting electrical boxes relative to a stud using at least one of a first support and a second support, the method comprising:
selecting a first support in a first configuration, in which the first support is configured to be secured to the stud without using tools and thereby to support a first of the electrical boxes relative to the stud at a first depth;
manipulating the first support into a second configuration, in which the first support remains configured to be secured to the stud without using tools, and in which the first support is configured to support the first electrical box relative to the stud at a second depth that is smaller than the first depth; and
securing the first support to the stud, in the second configuration, without using tools;
the operation of manipulating the first support into the second configuration including folding an attachment section of the first support over itself into a U-shaped bend.

19. The method of claim 18, further comprising:
securing the second support to the stud, without using tools, by seating a stud-engagement portion of the second support on a stud-engagement portion of the first support;
wherein each of the stud-engagement portions includes, respectively, at least one of a U-shaped profile and an L-shaped profile.

20. The method of claim 18, further comprising:
securing the first support in the second configuration by inserting a tab of the first support through an opening in the attachment section, and bending the tab to secure the tab within the opening.
